(19) United States
(12) Patent Application Publication
(10) Pub. No.: US 2012/0065559 A1
(43) Pub. Date: Mar. 15, 2012

(54) Massage Device for Massage Chair

(76) Inventors: Ko-Po Chen, Dali City (TW); Meng-Long Fang, Dali City (TW)

(21) Appl. No.: 12/903,398

(22) Filed: Oct. 13, 2010

(30) Foreign Application Priority Data
Sep. 10, 2010 (TW) 99130581

(51) Int. Cl. A61H 15/00

(52) U.S. Cl. 601/116

(57) ABSTRACT

A massage device for a massage chair includes a frame on which first, second, and third actuation mechanisms are mounted. A tappet is connected to each of two first swaying mechanisms connected to an actuation portion of the first actuation mechanism. Two second swaying mechanisms are connected to an actuation portion of the second actuation mechanism and each includes a bracket. Each of two rocker arm mechanisms has a connecting portion fixed to one of the tappets and a rocker arm with rollers. A push portion is provided at each rocker arm. A pressure device is mounted between each push portion and one of the brackets. The pressure devices transmit movement from the second swaying mechanisms to the rocker arm mechanisms to proceed with massage movement. A pressure of each pressure device can be increased or released to increase massaging pressure of the rocker arms and to absorb shock.

### BACKGROUND OF THE INVENTION

The present invention relates to a massage device for a massage chair and, more particularly, to a massage device that provides more comfortable massage effect and enhanced shock-absorbing effect by using a pressure device.

Taiwan Patent No. 1326595 discloses an angle adjusting mechanism for use in a massage device of a massage machine. The angle adjusting mechanism includes a kneading shaft driven by a motor to actuate two rocker arms, which, in turn, drive upper and lower massage wheels that perform predetermined massage movement. However, the massage travel of the rocker arms is limited by the maximum operational range of the kneading shaft and the transmission device. Thus, the upper and lower massage wheels can not be in complete contact with every portion of the body of the user. Particularly, the massage force is often insufficient in the recessed area of the back of the user. Furthermore, the force from the massage device is often too stiff to the user, because the force is directly transmitted to the body of the user. As a result, the user often feels uncomfortable during massage.

Thus, a need exists for an improved massage device that provides more comfortable massage effect and enhanced shock-absorbing effect.

### BRIEF SUMMARY OF THE INVENTION

The present invention solves this need and other problems in the field of comfortable massage by providing, in a preferred form, a massage device for a massage chair including a frame. A first actuation mechanism is mounted to the frame and includes a first motor and a first actuation portion operatively connected to the first motor. Two first swaying mechanisms are connected to the first actuation portion. A tappet is connected to each of the first swaying mechanisms. A second actuation mechanism is mounted to the frame and includes a second motor and a second actuation portion operatively connected to the second motor. Two second swaying mechanisms are connected to the second actuation portion. Each of the second swaying mechanisms includes a bracket. A third actuation mechanism is mounted to the frame and includes a third motor and a third actuation portion operatively connected to the third motor. The third actuation portion includes a gear. The gear is adapted to engage with a rack in the massage chair. Movement of the gear along the vertical rack causes a change in a position of the massage device. The massage device further includes two rocker arm mechanisms each having a connecting portion to which one of the tappets is fixed. Each rocker arm mechanism further includes a rocker arm having upper and lower ends. A roller rotatably mounted to each of the upper and lower ends of each rocker arm. A push portion is provided at each rocker arm. The tappets and the connecting portions are driven by the first swaying mechanisms to proceed with massage movement. A pressure device is mounted between each push portion and one of the brackets. The pressure devices transmit movement from the second swaying mechanisms to the rocker arm mechanisms to proceed with massage movement. A pressure of each pressure device can be increased or released to increase massaging pressure of the rocker arms and to absorb shock.

In the most preferred form, the frame includes a main board and first and second lateral boards on two sides of the main board. The first actuation mechanism is mounted to the main board. The second actuation mechanism is mounted to the first lateral board. The third actuation mechanism is mounted to the second lateral board. The first motor of the first actuation mechanism includes an output end. The first actuation portion includes a driven end connected to and driven by the output end. The second motor of the second actuation mechanism includes an output end. The second actuation portion includes a driven end connected to and driven by the output end of the second motor via a gear train for changing direction. A first bearing is mounted on an end of the second actuation portion and in the first lateral board. The first bearing is opposite to the gear train. The third motor includes an output end connected to the third actuation portion. The third actuation portion includes an end connected to another driven end via another gear train for changing direction, and a belt is mounted around the other driven end and the output end of the third motor. A second bearing is mounted on the third actuation portion and located in the second lateral board. Each of the brackets and the push portions includes a plurality fixing holes or openings. Each pressure device can be a hydraulic device using a fluid as a medium for increasing the pressure or an elastically pressure-increasing device with shock-absorbing effect.

The present invention will become clearer in light of the following detailed description of illustrative embodiments of this invention described in connection with the drawings.

### DESCRIPTION OF THE DRAWINGS

The illustrative embodiments may best be described by reference to the accompanying drawings where:

FIG. 1 shows a perspective view of a massage device for a massage chair according to the preferred teachings of the present invention.

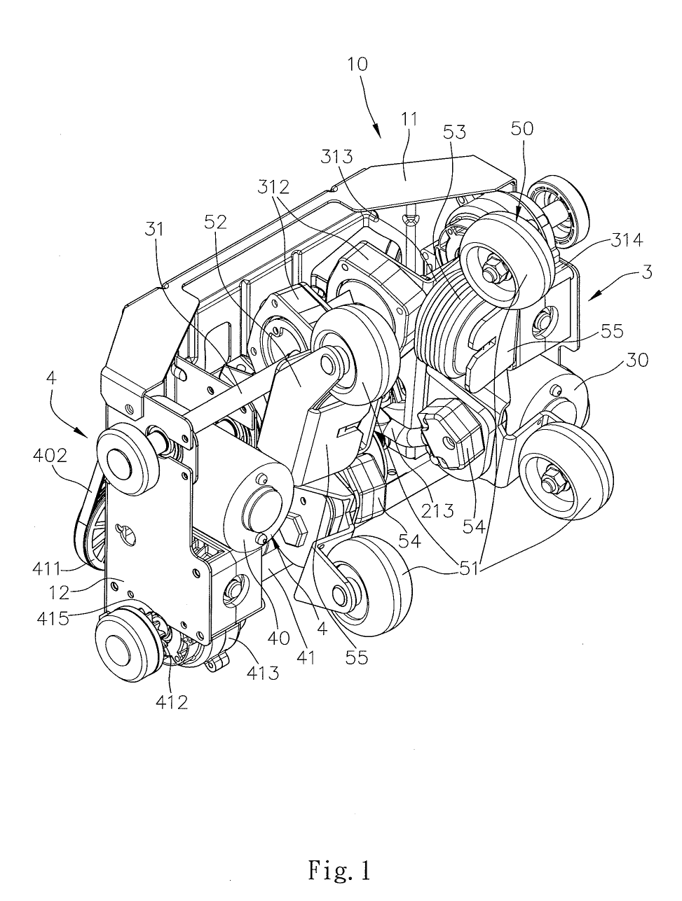

FIG. 2 shows another perspective view of the massage device of FIG. 1.

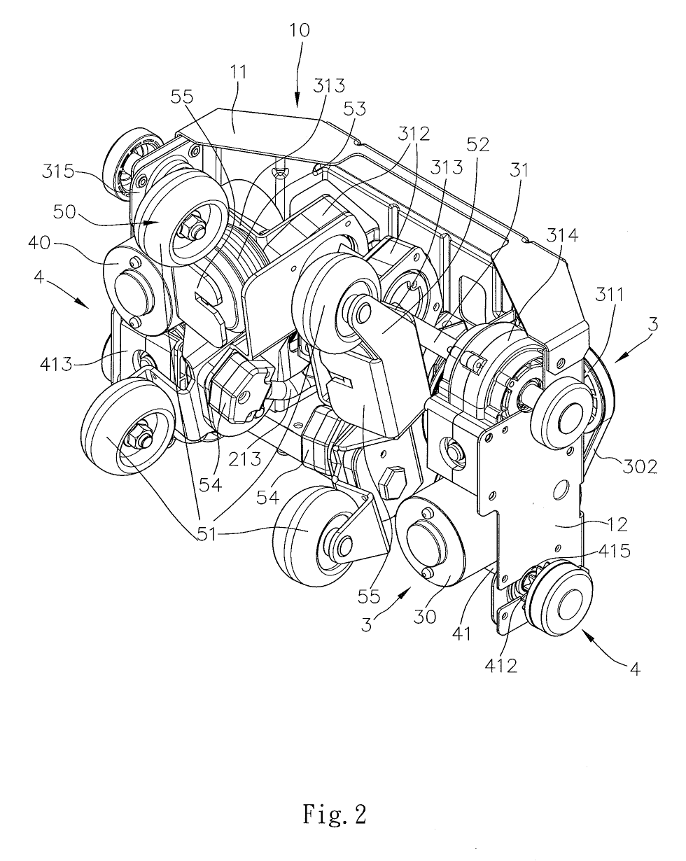

FIG. 3 shows a perspective view of the massage device of FIG. 1 with a pressure device actuated.

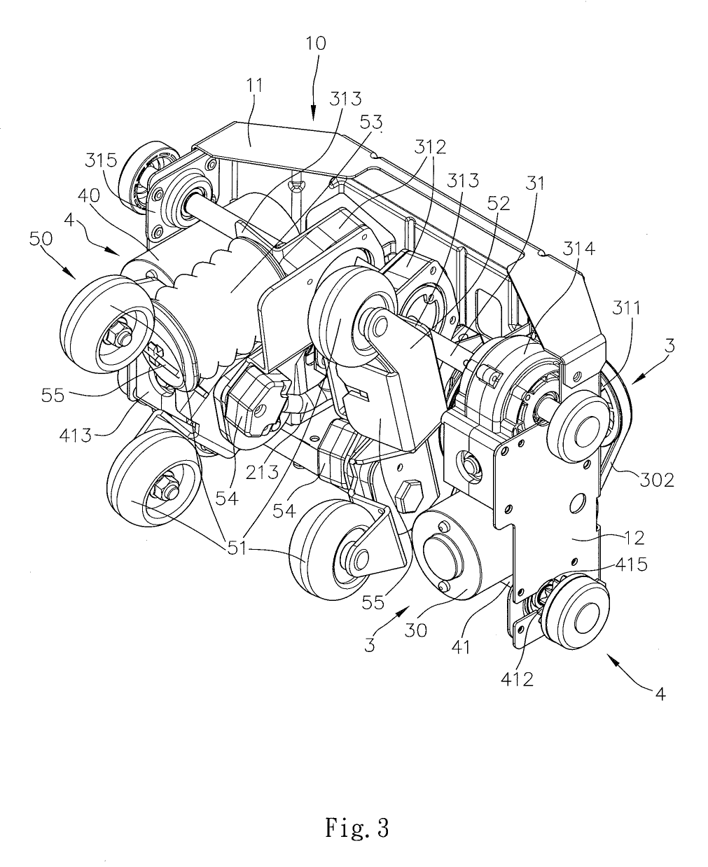

FIG. 4 shows a perspective view of the massage device of FIG. 3 with another pressure device actuated.

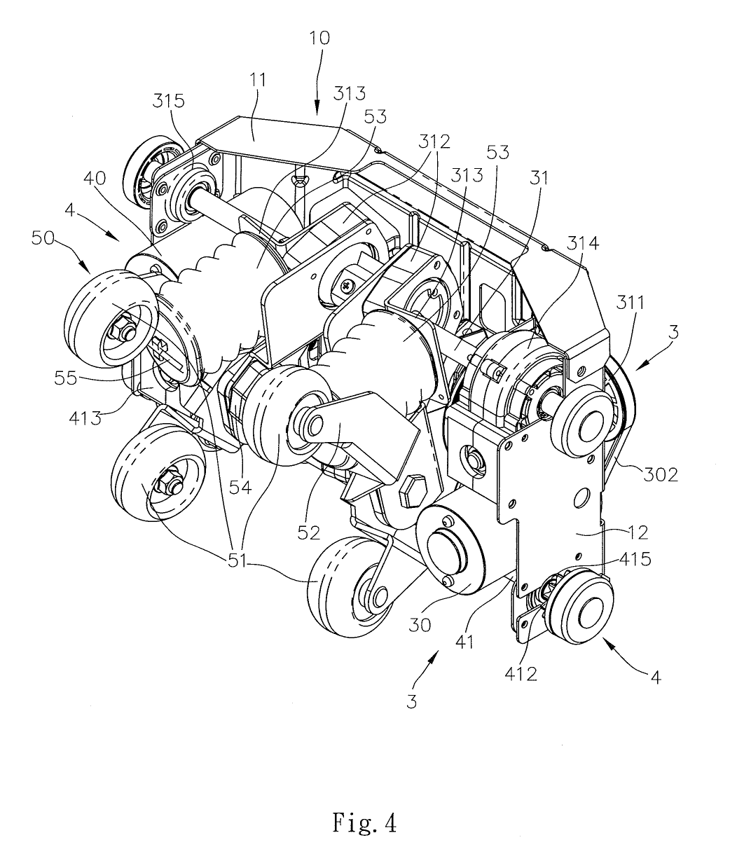

FIG. 5 shows a rear, perspective view of the massage device of FIG. 1.

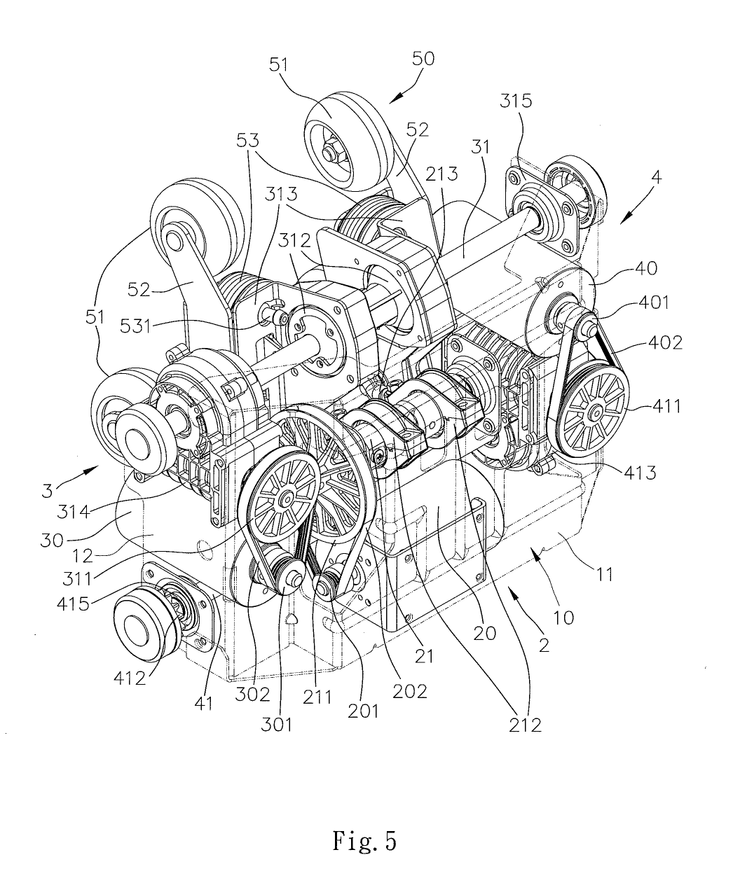

FIG. 6 shows a side view of the massage device of FIG. 1.

FIG. 7 shows a side view of the massage device of FIG. 6 with the pressure devices actuated.

FIG. 8 shows a front elevational view of the massage device of FIG. 1.

FIG. 9 shows a schematic view illustrating use of the massage device of FIG. 1 on a back of a user.

### DETAILED DESCRIPTION OF THE INVENTION

A massage device for a massage chair according to the preferred teachings of the present invention is shown in the drawings and generally includes a frame 10 having a main board 11 and two lateral boards 12 on two sides of the main board 11. Each of the main board 11 and the lateral boards 12 includes a plurality of fixing holes and openings for mounting the main structure of the massage device according to the preferred teachings of the present invention to proceed with desired movement. The main structure of the massage device according to the preferred teachings of the present invention includes a first actuation mechanism 2, a second actuation mechanism 3, a third actuation mechanism 4, and a pair of rocker arm mechanisms 50.

According to the preferred form shown, the first actuation mechanism 2 is mounted in a horizontal location at a bottom of the main board 11. The first actuation mechanism 2 includes a motor 20 having an output end 201 in the preferred form shown as a belt wheel for connecting a belt 202 for power output. The belt 202 is connected to a first actuation portion 21 in the form of a transmission shaft having a driven end 211 in the preferred form shown as a belt wheel around which the belt 202 is mounted. The ratio of the diameter of the driven end 211 to the diameter of the output end 201 can be designed based on the desired operational speed and the speed of the motor 20. The speed of the motor 20 can be controlled by a control system of the massage chair. Two swaying mechanisms 212 are symmetrically and pivotably mounted on an intermediate, rotating section of the first actuation portion 21. The swaying mechanisms 212 include cams, crankshafts, etc such that the swaying mechanisms 212 sway while the first actuation portion 21 rotates. Each swaying mechanism 212 includes a tappet 213 having a corresponding shape such that movement is transmitted to a front end of the tappet 213 while swaying mechanism 212 sways.

The second actuation mechanism 3 is mounted to one of the lateral board 12 and includes a motor 30 having an output end 301 in the preferred form shown as a belt wheel for connecting a belt 302 for power output. The belt 302 is connected to a second actuation portion 31 including a transmission shaft having an end connected to a driven end 311 via a gear train 314 for changing direction. The gear train 314 is driven by the driven end 311 in a desired direction. The driven end 311 is in the form of a belt wheel around which the belt 302 is mounted. The ratio of the diameter of the driven end 311 to the diameter of the output end 301 can be designed based on the desired operational speed and the speed of the motor 30. The speed of the motor 30 can be controlled by the control system of the massage chair. A bearing 315 is mounted on the other end of the transmission shaft of the second actuation portion 31. Two swaying mechanisms 312 are symmetrically and pivotably mounted on an intermediate, rotating section of the second actuation portion 31. The swaying mechanisms 312 include cams, crankshafts, etc such that the swaying mechanisms 312 sway while the second actuation portion 31 rotates. Each swaying mechanism 312 includes a bracket 313 having holes or openings for mounting purposes.

The third actuation mechanism 4 is mounted to the other lateral board 12 and includes a motor 40 having an output end 401 in the preferred form shown as a belt wheel for connecting a belt 402 for power output. The belt 402 is connected to a third actuation portion 41 including a transmission shaft having an end connected to a driven end 411 via a gear train 414 for changing direction. The gear train 414 is driven by the driven end 411 in a desired direction. The driven end 411 is in the form of a belt wheel around which the belt 402 is mounted. The mounting positions of the motor 40 and the gear train 414 correspond to those of the motor 30 and the gear train 314 but at opposite heights such that the third actuation portion 41 is located below the second actuation portion 31, reducing the overall volume of the whole structure. The ratio of the diameter of the driven end 411 to the diameter of the output end 401 can be designed based on the desired operational speed and the speed of the motor 40. The speed of the motor 40 can be controlled by the control system of the massage chair. A bearing 415 is mounted in the other lateral board 12 and on the other end of the transmission shaft of the third actuation portion 41, providing horizontal support at two ends of the transmission shaft. The third actuation portion 41 includes a gear 412 mounted on the other end of the transmission shaft and located on an outer side of the bearing 415.

Each rocker arm mechanism 50 includes a rocker arm 52 each having upper and lower ends. A roller 51 is rotatably mounted to each of the upper and lower ends of each rocker arm 52. A push portion 55 is provided at each rocker arm 52 and has holes or openings for mounting purposes. Specifically, a pressure device 53 is mounted between each push portion 55 and one of the brackets 313. In the most preferred form shown, the pressure device 53 includes a pneumatic rod and a pressure inlet 531 extending through the bracket 313 to engage with an air pipe (not shown). Through delivery of gas via the air pipe, the pressure device 53 can be inflated to move the push portion 55 forward. On the other hand, air can be released through the air pipe to move the push portion 55 backward. A longer massage travel is, thus, provided. Each rocker arm 52 has a connecting portion 54 to which one of the tappets 213 is fixed.

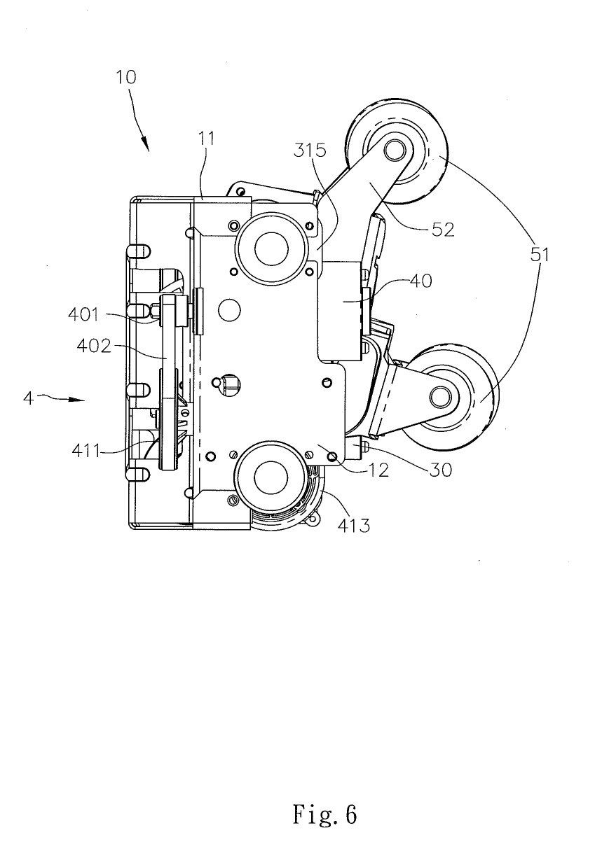

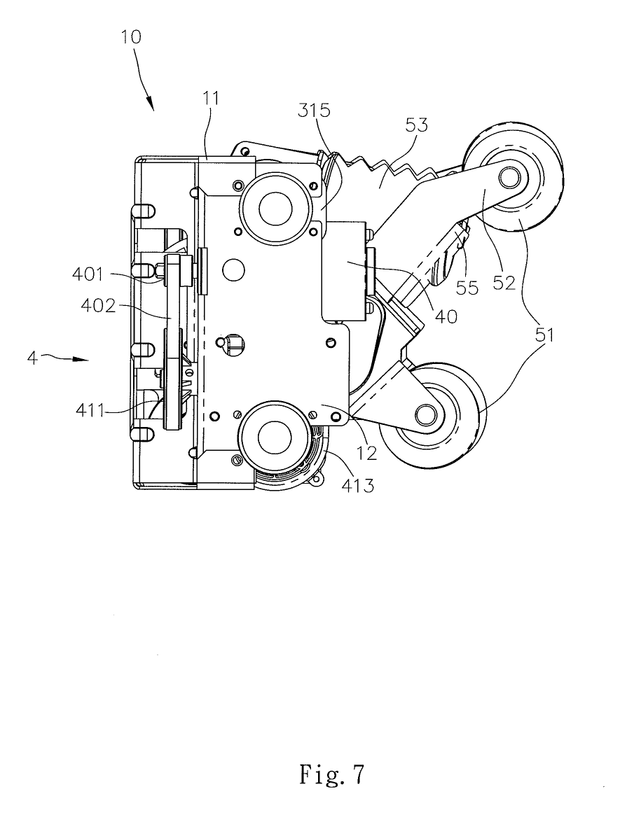

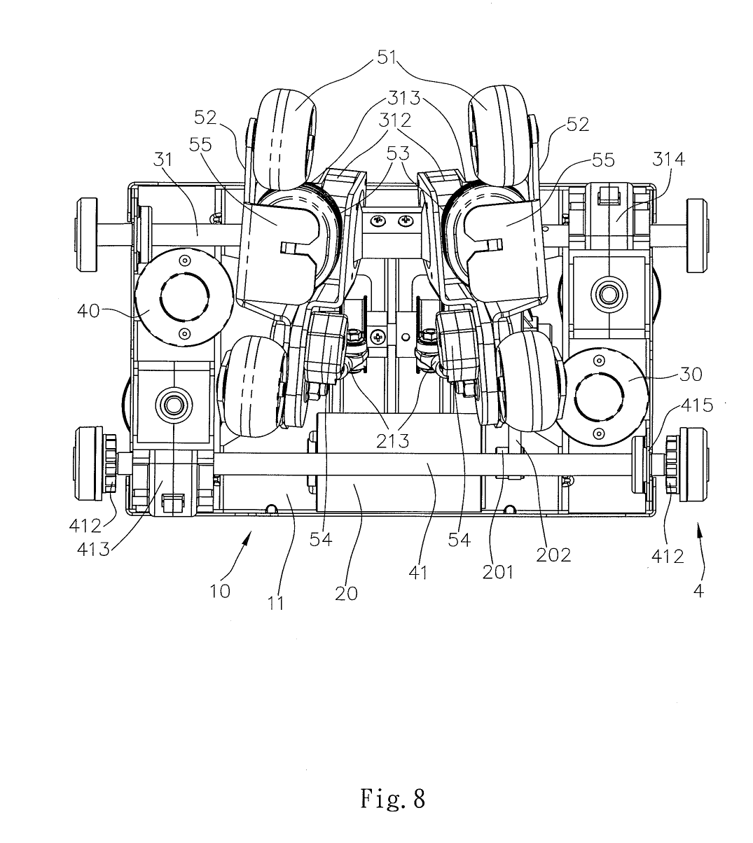

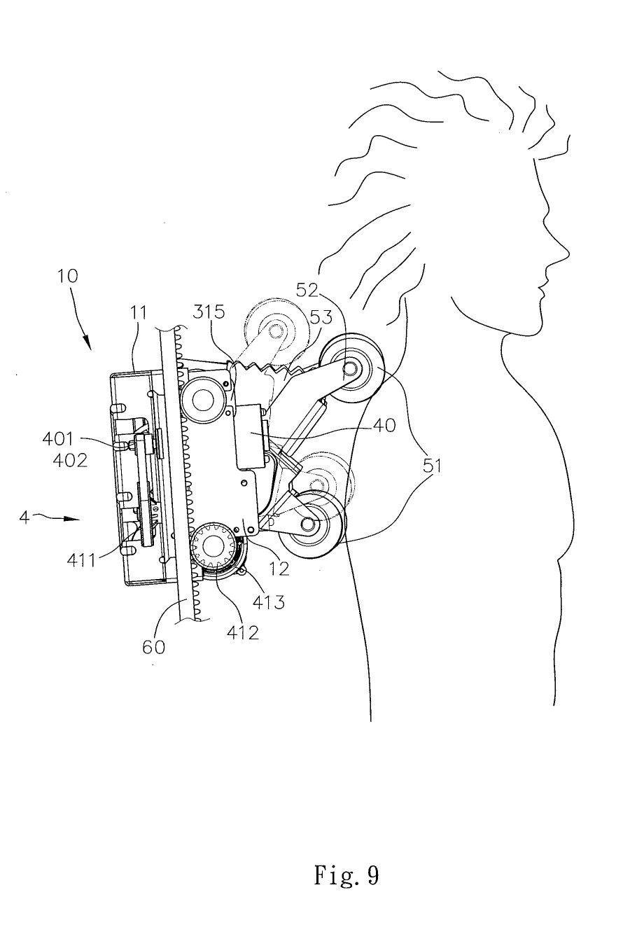

With reference to FIGS. 6-9, when the pressure devices 53 have not yet been pressurized, the rocker arm mechanisms 50 are driven by the swaying mechanisms 212 through pushing by the tappets 213 and driven by the swaying mechanism 312 through the brackets 312 and the push portions 55. The rocker arm mechanisms 50 can proceed with forward/rearward and leftward/rightward swaying movement. Furthermore, the height of the whole massage device can be adjusted through rotation of the gear 412 of the third actuation mechanism 4 along a vertical rack 60 in the massage chair. Further, through control by the programs of the massage chair, the rollers 51 of the rocker arm mechanisms 50 can proceed with upward, downward, leftward, rightward, forward, and rearward massaging movement. When it is desired to increase the massaging pressure imparted from the rollers 51 to the human body, the pressure devices 53 are pressurized and expand between the brackets 313 and the push portions 55 such that the rollers 51 on the upper ends of the rocker mechanisms 50 move toward and come in complete contact with the recessed portion of the back of the user. By increasing the pressure of the pressure devices 53, the increased pressure is more uniform and comfortable to the user, providing thorough massage to all of the portions of the back of the user and obtaining massage effect similar to that provided by human hands. Furthermore, by providing the pressure devices 53 between the brackets 313 and the push portions 55 with the pneumatic rods providing shock-absorbing effect, the swaying movement of the rocker arm mechanisms 50 becomes more comfortable to the user, avoiding stiff movement of machinery.

It can be appreciated that the positions of the brackets 313 and the push portions 55 are not limited to those described hereinbefore. The brackets 313 and the push portions 55 can be mounted to the first or second actuation portion 21 or 31 in a manner that the brackets 313 can be pushed to actuate the pressure devices 53 to move the push portions 55 and, thus, the rocker arm mechanisms 50. Furthermore, the pressure devices 53 can be hydraulic devices that use fluids as the media for increasing the pressure or elastically pressure-increasing devices with shock-absorbing effect, obtaining comfort and shock-absorbing massage effect while increasing the massaging pressure.

Although specific embodiments have been illustrated and described, numerous modifications and variations are still possible without departing from the essence of the invention. The scope of the invention is limited by the accompanying claims.

1. A massage device for a massage chair comprising:
a frame;
a first actuation mechanism mounted to the frame and including a first motor and a first actuation portion operatively connected to the first motor, with two first swaying mechanisms connected to the first actuation portion, with a tappet connected to each of the first swaying mechanisms;
a second actuation mechanism mounted to the frame and including a second motor and a second actuation portion operatively connected to the second motor, with two second swaying mechanisms connected to the second actuation portion, with each of the second swaying mechanisms including a bracket;
a third actuation mechanism mounted to the frame and including a third motor and a third actuation portion operatively connected to the third motor, with the third actuation portion including a gear, with the gear adapted to engage with a rack in the massage chair, with movement of the gear along the vertical rack causing a change in a position of the massage device;
two rocker arm mechanisms each including a connecting portion to which one of the tappets is fixed, with each of the two rocker arm mechanisms further including a rocker arm having upper and lower ends, with a roller rotatably mounted to each of the upper and lower ends of each of the rocker arms, with a push portion provided at each of the rocker arms, with the tappets and the connecting portions driven by the first swaying mechanisms to proceed with massage movement; and
a pressure device mounted between each of the push portions and one of the brackets, with the pressure devices transmitting movement from the second swaying mechanisms to the two rocker arm mechanisms to proceed with massage movement, with a pressure of each of the pressure devices capable of being increased or released to increase massaging pressure of the rocker arms and to absorb shock.

2. The massage device for a massage chair as claimed in claim 1, with the frame including a main board and first and second lateral boards on two sides of the main board, with the first actuation mechanism mounted to the main board, with the second actuation mechanism mounted to the first lateral board, with the third actuation mechanism mounted to the second lateral board.

3. The massage device for a massage chair as claimed in claim 1, with the first motor of the first actuation mechanism including an output end, with the first actuation portion including a driven end, with the driven end connected to and driven by the output end.

4. The massage device for a massage chair as claimed in claim 1, with the second motor of the second actuation mechanism including an output end, with the second actuation portion including a driven end, with the driven end connected to and driven by the output end.

5. The massage device for a massage chair as claimed in claim 4, with the second actuation portion connected to the driven end via a gear train for changing direction.

6. The massage device for a massage chair as claimed in claim 5, with a first bearing mounted on an end of the second actuation portion and in the first lateral board, with the first bearing opposite to the gear train.

7. The massage device for a massage chair as claimed in claim 6, with the third motor including an output end connected to the third actuation portion.

8. The massage device for a massage chair as claimed in claim 7, with the third actuation portion including an end connected to another driven end via another gear train for changing direction, with a belt mounted around the other driven end and the output end of the third motor.

9. The massage device for a massage chair as claimed in claim 8, with a second bearing mounted on the third actuation portion and located in the second lateral board.

10. The massage device for a massage chair as claimed in claim 1, with each of the brackets and the push portions including a plurality fixing holes or openings, with each of the pressure devices being a hydraulic device using a fluid as a medium for increasing the pressure or an elastically pressure-increasing device with shock-absorbing effect.
